(19) United States
(12) Patent Application Publication
(10) Pub. No.: US 2007/0059091 A1
(43) Pub. Date: Mar. 15, 2007

(54) Ball and socket joint for a motor vehicle

(76) Inventors: Joachim Spratte, Osnabruck (DE); Michael Klank, Osnabruck (DE)

Correspondence Address: MCGLEW & TUTTLE, PC, P.O. BOX 9227, SCARBOROUGH STATION, SCARBOROUGH, NY, 10510-9227, US

(21) Appl. No.: 10/595,229

(22) PCT Filed: Oct. 1, 2004
(86) PCT No.: PCT/DE04/02204

§ 371 Date: Mar. 28, 2006

(30) Foreign Application Priority Data
Oct. 10, 2003 (DE) 103 47 814.0

(51) Int. Cl. G01M 13/00

(52) U.S. Cl. 403/27

(57) ABSTRACT

A ball and socket joint for a motor vehicle has a ball pivot (3), which has a pin (2) and a joint ball (1). The ball pivot (3) is arranged with its joint ball (1) rotatably and pivotably in a recess (4) provided in a housing (5), and extends from this housing (5) through a pin opening (6), and with a sensor, which is a moisture sensor (12) and is in connection with the recess (4).

### CROSS REFERENCE TO RELATED APPLICATIONS

This application is a United States National Phase application of International Application PCT/DE 2004/002204 and claims the benefit of priority under 35 U.S.C. § 119 of German Application DE 103 47 814.0 filed Oct. 10, 2003, the entire contents of which are incorporated herein by reference.

### FIELD OF THE INVENTION

The present invention pertains to a ball and socket joint for a motor vehicle, with a ball pivot, which has a pin and a joint ball and is arranged with its joint ball rotatably and pivotably in a recess provided in a housing and extends from that [housing] through a pin opening, and with a sensor.

### BACKGROUND OF THE INVENTION

Such a ball and socket joint is known from DE 101 61 671 A1, where a magnetic field sensor is arranged at a closing element, which closes a mounting opening provided in a housing. The magnetic field sensor is arranged in the housing and is completely covered by a protective element.

Ball and socket joints for motor vehicles frequently have the drawback that moisture can penetrate into the interior space of the ball and socket joint, e.g., because of a defective seal, so that the ball surface of the joint ball of the ball and socket joint corrodes. However, such a corrosion may lead to major impairment of the function of the joint and even to destruction thereof in an extreme case. Since ball and socket joints for motor vehicles are also used in the area of the chassis and are therefore safety-relevant components, it is important to recognize an incipient corrosion early.

### SUMMARY OF THE INVENTION

Based on this state of the art, the object of the present invention is to provide a ball and socket joint for a motor vehicle, in which the possible onset of corrosion can be recognized early.

According to the invention, a ball and socket joint is provided for a motor vehicle and has a ball pivot, which has a pin and a joint ball. The pin is arranged with its joint ball rotatably and pivotably in a recess provided in a housing. The pin extends from this housing through a pin opening. A sensor in the form of a moisture sensor is provided in connection (functional/operative connection) with the recess.

With the ball and socket joint according to the present invention, it is possible to recognize the penetration of moisture into the interior space of the ball and socket joint very early, which is important, e.g., during the phase of development of a ball and socket joint in order to achieve rapid and efficient optimization of all sealing points. Defective sealing points may develop, e.g., at a sealing bellows or at a housing cover. However, the ball and socket joint according to the present invention has advantages over conventional ball and socket joints not only during the phase of development and construction but also in serial use, because damage to sealing points can be detected early before the carrying properties of the ball and socket joint are compromised. The safety of the vehicle is substantially improved as a result. Furthermore, costs can be saved in the repair of the ball and socket joint, because it is no longer necessary to always completely replace the ball and socket joint when only the sealing bellows is damaged. Due to the early recognition of the penetration of moisture and consequently of the risk for corrosion, it may be sufficient, e.g., to replace only a defective sealing bellows when the surface of the joint ball is not yet corroded. However, if the penetration of moisture into the ball and socket joint is recognized early, the joint ball is usually not corroded, so that not only can material costs be saved, but the installation effort will be lower as well.

The sensor may be in connection with the recess via an opening provided in the housing and be arranged itself outside the housing. However, the moisture sensor is preferably fastened at or in the housing, being arranged especially in the recess. Since ball and socket joints frequently have a mounting opening closed by means of a housing cover in the area of the housing facing away from the pin opening, the moisture sensor is preferably arranged in the area of the housing facing away from the pin opening. Simple mounting of the moisture sensor is thus possible, and it can also be held by the housing cover.

According to a first alternative, the moisture in the ball and socket joint is measured by measuring the humidity of the air surrounding the sensor, the air flowing through at least part of the recess and/or being in contact with or interacting with a lubricant present in the recess. The humidity of the air measured in this air is an indicator of the total amount of air having penetrated into the interior of the ball and socket joint, but this air should not mix with atmospheric air.

If a lubricant is provided in the recess of the housing, the moisture sensor for measuring the humidity of the air must be separated from the lubricant to enable the air to reach the sensor unhindered. A protective wall, which is provided with passage openings, which preferably extend all around a central wall area of the protective wall, may be arranged for this purpose between the moisture sensor and the recess. The sensor may be arranged now on the side of the central wall area facing away from the recess and can be separated by it from the recess. Furthermore, the air may circulate through the passage openings and interact with both the moisture sensor and the lubricant arranged in the recess.

The moisture sensor may have two electrodes, between which a material that is sensitive to moisture from an electrical point of view is arranged. In particular, the moisture sensor is designed as a capacitive moisture sensor, where a moisture-sensitive dielectric, which can absorb moisture, is arranged between two electrodes in a gap. The quantity of moisture absorbed by the dielectric depends on the moisture conditions in the immediate environment of the dielectric, the capacity of the moisture sensor changing as a function of the quantity of moisture absorbed by the dielectric. The quantity of moisture absorbed by the dielectric can thus be determined by measuring the capacity of the moisture sensor. A hygroscopic layer proved to be suitable for the dielectric, the preferred materials for the dielectric being polyamide or aluminum oxide, which may be designed especially in the form of a film or foil.

If a lubricant is introduced into the recess of the ball and socket joint, the dielectric may, however, also be formed by part of this lubricant, in which case the capacity of the moisture sensor varies as a function of the quantity of moisture absorbed by the lubricant. The sensor is preferably arranged now in an area of the ball and socket joint where frequent movement of the lubricant takes place during the operation of the ball and socket joint, so that the gap between the electrodes is completely filled with lubricant, on the one hand, and, on the other hand, the lubricant present between the electrodes can be replaced by this movement with lubricant present outside the gap. Consequently, the measured moisture content of the lubricant present between the electrodes also represents the moisture content of the lubricant provided outside the gap and thus the total quantity of moisture having penetrated into the recess of the ball and socket joint.

The electrodes may be designed as bent electrodes, e.g., as bent metal plates, where the gap filled with the dielectric is provided between the electrodes. In particular, it is possible to apply the straight or bent electrodes on a substrate in such a way that they are connected in substance, where layers applied on the substrate galvanically or conductive coatings applied on the substrate galvanically are suitable for use as electrodes. If the joint ball is arranged in the housing via the intermediary of a calotte shell, this may form the substrate for the electrodes. However, it is also possible that the substrate is formed by a housing of a sensor assembly unit or that the electrodes are arranged on a housing of the sensor assembly unit, the sensor assembly unit being defined as an arrangement that has, besides the moisture sensor proper, at least a housing, preferably also an electronic circuit, which can perform, e.g., a temperature compensation or linearization for the signals measured by the sensor.

However, the above-described moisture sensor with two electrodes may also be used to measure the electric conductivity of a moisture-sensitive material, which is arranged between the electrodes and whose conductivity changes as a function of the quantity of moisture absorbed by it. Thus, the measured conductivity of the material arranged between the electrodes is also a suitable variable for determining the quantity of moisture having penetrated into the recess of the ball and socket joint. Since real dielectrics regularly also have an electric conductivity, an aforementioned dielectric may also be used for this moisture-sensitive material.

The present invention will be described below on the basis of preferred embodiments with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a schematic sectional view of a first embodiment of the ball and socket joint according to the present invention;

FIG. 2 is a top view of the protective wall and the sensor according to FIG. 1;

FIG. 3 is a schematic sectional view of a second embodiment of the ball and socket joint according to the present invention;

FIG. 4 is an enlarged sectional view of the moisture sensor shown in FIG. 3;

FIG. 5 is a sectional view of the moisture sensor according to FIG. 4;

FIG. 6 is a schematic sectional view of a third embodiment of the ball and socket joint according to the present invention;

FIG. 7 is a schematic view of a sensor assembly unit;

FIG. 8 is a sectional view of a moisture sensor with a dielectric, and

FIG. 9 is a schematic sectional view of a fourth embodiment of the ball and socket joint according to the present invention.

### DESCRIPTION OF THE PREFERRED EMBODIMENTS

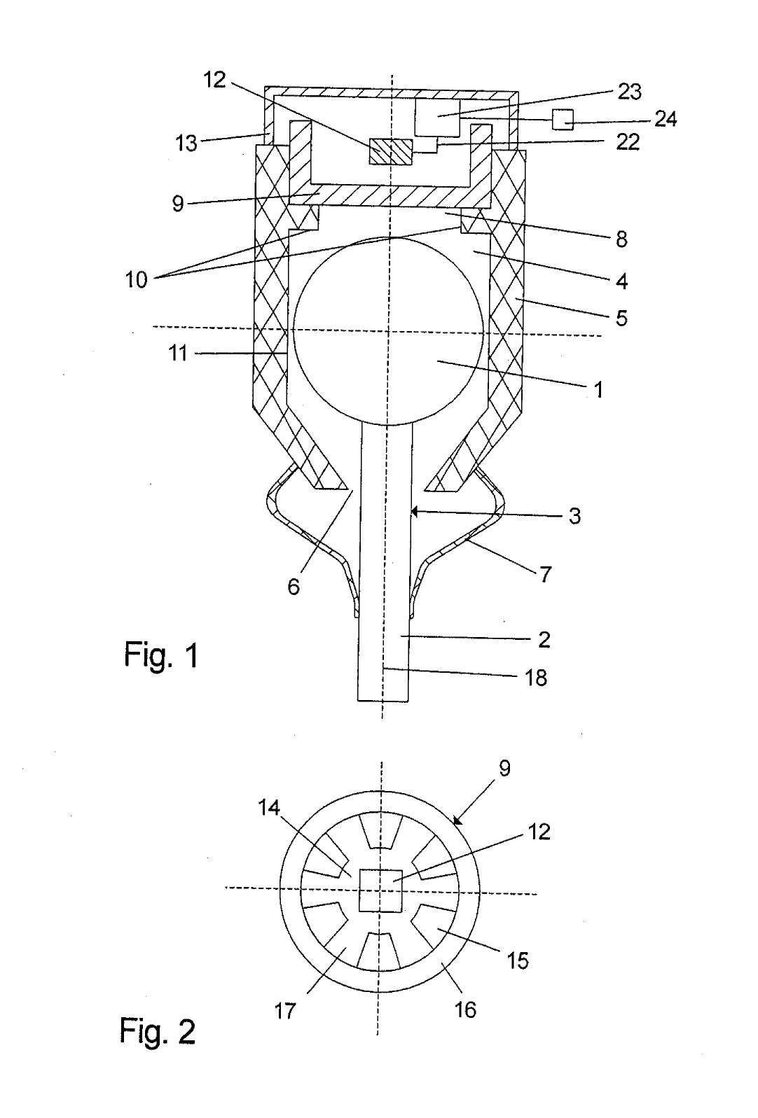

Referring to the drawings in particular, FIG. 1 shows a sectional view of a first embodiment of the ball and socket joint according to the present invention, wherein a ball pivot 3 having a joint ball 1 and a pin 2 is mounted rotatably and pivotably in a recess 4 in a ball and socket joint housing 5. The ball pivot 3 extends with its pin 2 from the housing 5 from a pin opening 6 provided in the housing 5, the pin opening 6 being protected by an elastic sealing bellows 7 against the penetration of moisture. On the side facing away from the pin 2, the housing 5 has a mounting opening 8, in which a protective wall 9 is arranged. The protective wall 9 is in contact with a projection 10, which is formed on the inner wall 11 of the housing 5. The recess 4 is filled with a lubricant, so that the sliding properties of the joint ball 1 in the housing 5 are improved and the joint ball is protected against corrosion. A moisture sensor 12, which is designed as a humidity sensor with two electrodes and a hygroscopic layer located between them, is arranged on the side of the protective wall 9 facing away from the joint wall 1. The moisture sensor 12 is protected by a cover 13 attached to the housing 5 from undesired external effects, e.g., the unhindered penetration of atmospheric air.

FIG. 2 shows a top view of the protective wall 9 and the moisture sensor 12, which is arranged at or above a central wall area 14 of the protective wall 9. A plurality of passage openings 15, which make possible the passage of air from the recess 4 into the area surrounding the moisture sensor 12 and vice versa, so that the air can circulate freely between the moisture sensor 12 and the recess 4, are formed around this central wall area 14 in the protective wall 9.

The passage openings 15 extend from the central wall area 14 to the wall 16 of the protective wall 9, there extending a web 17, which connects the central wall area 14 with the wall 16, between two adjacent passage openings 15. Like the passage openings 15, the webs 17 are also arranged around the central wall area 14, which protects the moisture sensor 12 designed as a humidity sensor from contact with lubricant.

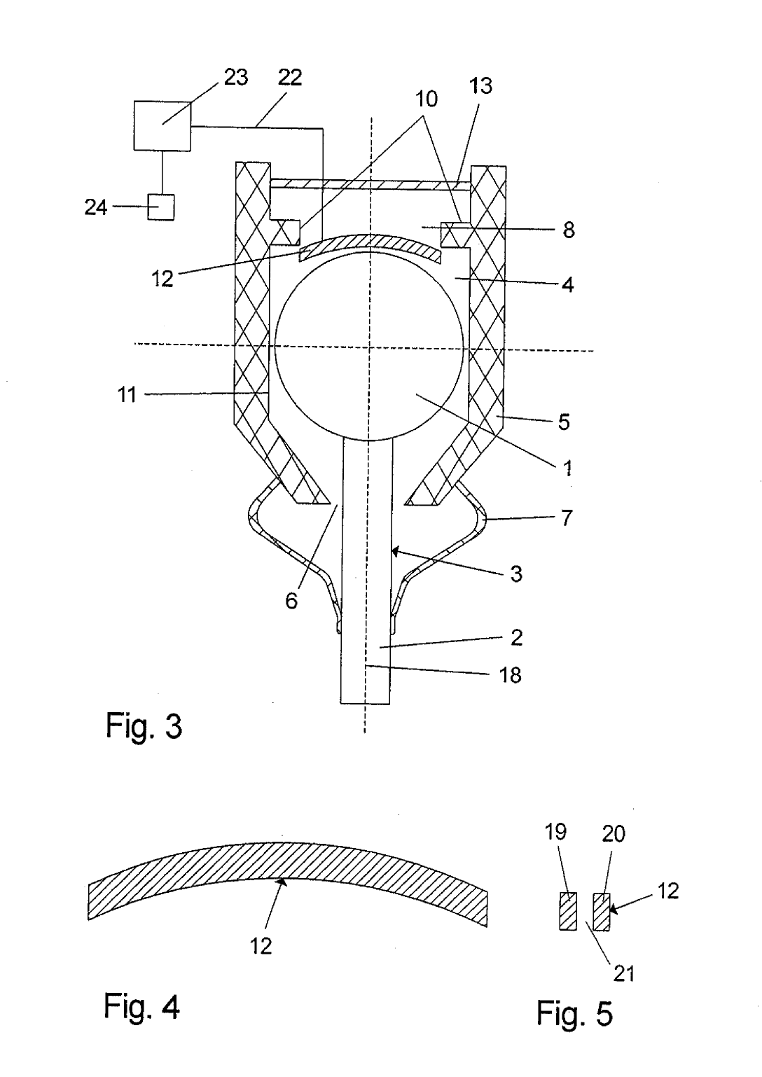

FIG. 3 shows a sectional view of a second embodiment of the ball and socket joint according to the present invention, where identical or similar features are designated by the same reference numbers as in the first embodiment. The moisture sensor 12 is designed according to this embodiment as a pair of bent metal plates, which is bent, beginning from the central longitudinal axis 18 of the ball and socket joint, into the recess 4 on both sides.

FIG. 4 shows an enlarged view and FIG. 5 shows a sectional view of the moisture sensor 12 from FIG. 3, where a gap 21 is provided between the metal plates 19 and 20 forming the pair of metal plates. A lubricant is introduced into the recess 4, and the gap 21 is also filled completely with the lubricant. Due to this arrangement and design of the moisture sensor 12, it is achieved that an exchange of lubricant takes place between the recess 4 and the gap 21 during a movement of the joint ball 1. Thus, the moisture content in the lubricant present in the gap 21 represents the moisture content of the lubricant in the recess 4.

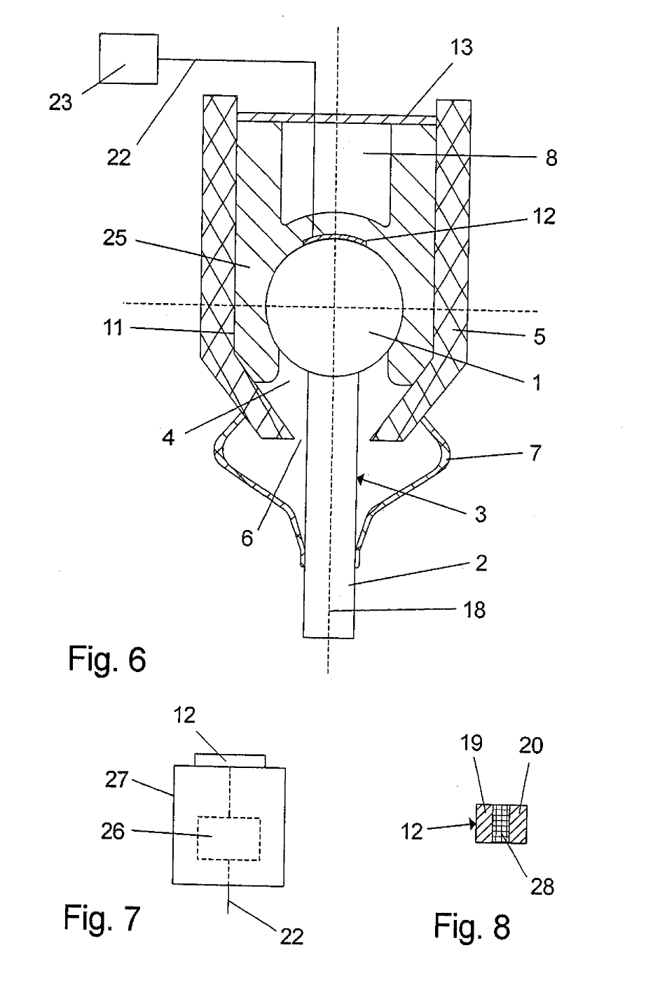

FIG. 6 shows a schematic sectional view of a third embodiment of the ball and socket joint according to the present invention, where identical or similar features are designated by the same reference numbers as in the preceding embodiments. According to this embodiment, the joint ball 1 is mounted in the recess 4 of the housing 5 via the intermediary of a calotte shell or bearing shell 25, and the electrodes of the moisture sensor 12 are formed by galvanic layers or conductive coatings on the calotte shell 25. A lubricant, which completely fills the gap formed between the electrodes, is introduced into the recess 4 in this embodiment as well.

FIG. 7 shows a sensor assembly unit, which can replace the moisture sensor used in the preceding embodiments. According to this sensor assembly unit, the moisture sensor 12 forms a structural unit together with the sensor assembly unit housing 27 and an electronic circuit 26, which is arranged within the sensor assembly unit housing 27 and is used to process information obtained by the moisture sensor 12. The moisture sensor 12 is fastened on the outer side of the sensor assembly unit housing 27.

FIG. 8 shows a sectional use of a moisture sensor 12 used, where the moisture-sensitive material 28 or dielectric, which may consist of a hygroscopic layer, e.g., one made of polyamide or aluminum oxide or lubricant, depending on the embodiment, and is introduced into the gap 21 between the two electrodes 19 and 20, is shown, contrary to FIG. 5.

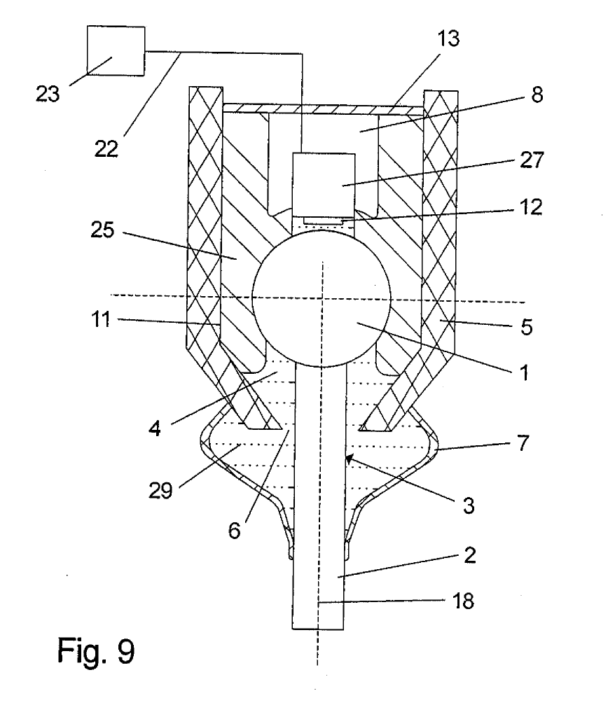

FIG. 9 shows a schematic sectional view of a fourth embodiment of the ball and socket joint according to the present invention, where identical or similar features are designated by the same reference numbers as in the preceding embodiments. According to this embodiment, a sensor assembly unit with a sensor assembly unit housing 27 is inserted into the calotte shell 25, and the moisture sensor 12 is arranged at the sensor assembly unit housing 27 such that it faces the joint ball 1. Furthermore, the lubricant 29 introduced into the recess 4, which also fills completely the gap present between the electrodes of the moisture sensor 21, is indicated by dotted lines in this figure.

Even though a lubricant may be provided in the recess 4 in all embodiments, the lubricant is not represented in FIGS. 1, 3, 5 and 6 for clarity's sake.

According to FIGS. 1, 3, 6 and 9, the moisture sensor 12 is contacted with electric lines 22, which are connected to an electronic evaluating unit 23, which is arranged within the ball and socket joint according to FIG. 1 and outside the ball and socket joint according to FIGS. 3, 6 and 9. According to FIGS. 1 and 3, this evaluating unit 23 is connected, furthermore, to a signal transmitter 24, which is arranged within the passenger compartment of the motor vehicle and informs the driver of the vehicle on whether the quantity of moisture having penetrated into the recess 4 has exceeded a permissible limit value of the quantity of moisture. However, it is also possible that the quantity of moisture measured in the recess 4 by the moisture sensor 12 is stored in a memory, which is provided in the evaluating unit 23 and can be read during the maintenance of the motor vehicle. As is apparent from FIGS. 6 and 9, the signal transmitter 24 may be done away with in this case.

While specific embodiments of the invention have been shown and described in detail to illustrate the application of the principles of the invention, it will be understood that the invention may be embodied otherwise without departing from such principles.

1. A ball and socket joint for a motor vehicle, the ball and socket joint comprising:
a ball pivot with a pin and a joint ball;
a housing having a recess, said ball pivot being arranged with said joint ball rotatably and pivotably in said recess provided in said housing and extending out of said housing through a pin opening; and
a moisture sensor in operative connection with said recess.

2. A ball and socket joint in accordance with claim 1, wherein said moisture sensor is fastened in or at the housing.

3. A ball and socket joint in accordance with claim 1, wherein said moisture sensor is arranged in said recess.

4. A ball and socket joint in accordance with, claim 1, wherein said moisture sensor is arranged in an area of the housing facing away from said pin opening.

5. A ball and socket joint in accordance with claim 1, further comprising: a protective wall provided with passage openings and arranged between said moisture sensor and said recess.

6. A ball and socket joint in accordance with claim 5, wherein said passage openings extend around a central wall area.

7. A ball and socket joint in accordance with, claim 1, wherein said moisture sensor has two electrodes, between which a material, which is sensitive to moisture from an electrical point of view, is arranged.

8. A ball and socket joint in accordance with claim 7, wherein said moisture-sensitive material is a moisture-sensitive dielectric.

9. A ball and socket joint in accordance with claim 7, wherein said moisture-sensitive material is formed by a hygroscopic layer.

10. A ball and socket joint in accordance with claim 7, wherein said moisture-sensitive material consists of polyamide film or aluminum oxide.

11. A ball and socket joint in accordance with claim 7, further comprising: a lubricant introduced into the recess and the moisture-sensitive material is formed by at least part of said lubricant.

12. A ball and socket joint in accordance with claim 7, wherein said electrodes are designed as bent metal plates.

13. A ball and socket joint in accordance with claim 7, wherein said electrodes are formed by galvanic layers or conductive coatings.

14. A ball and socket joint in accordance with, claim 1, wherein said joint ball is arranged in the housing via the intermediary of a bearing shell.

15. A ball and socket joint in accordance with claim 14, wherein said moisture sensor is provided at the bearing shell.

16. A ball and socket joint in accordance with, claim 1, wherein said moisture sensor is arranged at a sensor assembly unit housing.

17. A ball and socket joint for a motor vehicle, the ball and socket joint comprising:
a ball pivot with a pin and a joint ball;
a housing defining a recess, said joint ball being seated in said recess of said housing for rotatable and pivotable movement in said recess, said pin extending out of said recess of said housing through a pin opening; and
a moisture sensor connected to said housing for sensing a degree of moisture in said recess.

18. A ball and socket joint in accordance with claim 17, wherein said moisture sensor is fastened indirectly or directly to said housing and said moisture sensor is arranged in operative connection with an area of the housing facing away from said pin opening.

19. A ball and socket joint in accordance with claim 17, further comprising: a protective wall provided with passage openings and arranged between said moisture sensor and said recess.

20. A ball and socket joint in accordance with claim 19, wherein said passage openings extend around a central wall area.
